(19) United States
(12) Patent Application Publication
(10) Pub. No.: US 2016/0366394 A1
(43) Pub. Date: Dec. 15, 2016

(54) STEREOGRAPHIC IMAGE CAPTURING APPARATUS HAVING INTEROCULAR DISTANCE CONTROLLER AND METHOD FOR CONTROLLING DEPTH PERCEPTION OF STEREOGRAPHIC IMAGE USING THE SAME

(71) Applicant: REDROVER CO., LTD., Seongnam-si (KR)

(72) Inventors: Jung Il PARK, Seongnam-si (KR); Young Hun KIM, Yongin-si (KR); Dong Soo KIM, Gwangju-si (KR); Jun Woo SEOUNG, Seongnam-si (KR)

(21) Appl. No.: 14/746,489

(22) Filed: Jun. 22, 2015

(30) Foreign Application Priority Data
Jun. 11, 2015 (KR) 10-2015-0082495

(51) Int. Cl. H04N 13/02; H04N 5/225; H04N 5/232

(52) U.S. Cl. CPC H04N 13/0239; H04N 5/23296; H04N 5/2251

(57) ABSTRACT

The present invention relates to a method for controlling the depth perception of a stereographic image which uses a camera rig control module and automatically controls the interocular distance between a left-eye camera and a right-eye camera depending on the image capturing distance, which changes when the left- and right-eye cameras are zoomed in or out.

The present invention is to provide an apparatus for capturing stereographic images, which can automatically control the interocular distance of a camera module depending on a change in an image capturing distance such that the interocular distance becomes the optimum value corresponding to the changed image capturing distance, thus preventing the depth perception of stereographic images from varying rapidly, and controlling variation in the depth perception of stereographic images, thereby reducing eye strain of a viewer. Furthermore, another object of the present invention is to provide a method for controlling the depth perception of stereographic images using the apparatus.

### BACKGROUND OF THE INVENTION

1. Field of the Invention

The present invention generally relates to stereographic image capturing apparatuses having interocular distance controllers and methods for controlling the depth perception of stereographic images using the apparatuses. More particularly, the present invention relates to a method for controlling the depth perception of a stereographic image which uses a camera rig control module and automatically controls the interocular distance between a left-eye camera and a right-eye camera depending on the image capturing distance, which changes when the left- and right-eye cameras are zoomed in or out.

2. Description of the Related Art

Generally, a left-eye image and a right-eye image must be captured in order to obtain a stereographic image. Furthermore, the positions and orientations of the left- and right-eye images must be adjustable so that the distance therebetween, the angle relative to each other, etc. can be adjusted. To achieve the above-mentioned purposes, there is the need for an apparatus on which a left-eye camera for capturing a left-eye image and a right-eye camera for capturing a right-eye image are movably installed. This apparatus is typically called a stereographic camera rig.

The depth perception of stereographic images depends significantly on three factors, namely the interocular distance (IOD), the vergence angle between a left-eye camera and a right-eye camera, and the distance between the cameras and a target. If any one of these three factors varies, the depth perception of stereographic images also varies.

For viewers who watch stereographic images, smoothly retaining the depth perception of stereographic images within an appropriate range, rather than rapidly varying the depth perception, is required in order to reduce eye strain of the viewers and enhance the quality of images.

Therefore, there is the need for a method of preventing the depth perception of stereographic images from rapidly varying even when one or more of the three factors, that is, the interocular distance, the vergence angle, and the distance between the cameras and the target, is varied. Particularly, during a zooming-in or -out image capturing operation using a zoom lens, variation in the interocular distance that is smoothly coordinated with the image capturing operation is urgently required.

### SUMMARY OF THE INVENTION

Accordingly, the present invention has been made keeping in mind the above problems occurring in the prior art, and an object of the present invention is to provide an apparatus for capturing stereographic images, which can automatically control the interocular distance of a camera module depending on a change in an image capturing distance such that the interocular distance becomes the optimum value corresponding to the changed image capturing distance, thus preventing the depth perception of stereographic images from varying rapidly, and controlling variation in the depth perception of stereographic images, thereby reducing eye strain of a viewer. Furthermore, another object of the present invention is to provide a method for controlling the depth perception of stereographic images using the apparatus.

In order to accomplish the above object, the present invention provides a method for controlling depth perception of a stereographic image using a stereographic image capturing apparatus including a camera module, a camera rig, and a camera rig control module, the camera module including a left-eye camera and a right-eye camera, the method comprising: creating an interocular distance DB (database) including information both about an interocular distance determined at a reference distance and about an interocular distance to be changed when an image capturing distance is changed by zooming in or out at the reference distance, and storing the interocular distance DB in the camera rig control module; using, in the camera rig control module, when the camera module including the left-eye camera and the right-eye camera is zoomed in or out at the reference distance, a change value of lens data changed by the zooming in or out and calculating an image capturing distance changed by zooming in or out on a target; and finding, from the interocular distance DB, a new interocular distance value corresponding to the image capturing distance changed by zooming in or out, and adjusting, by means of rotating motors installed in the camera rig control module, the interocular distance of the camera module to the new interocular distance value found from the interocular distance DB.

In a preferred embodiment of this invention, the adjusting the interocular distance of the camera module comprises using a speed at which the lens data varies and calculating a speed of the zooming in or out and controlling a speed at which the interocular distance is adjusted corresponding to the speed of the zooming in or out.

In a preferred embodiment of this invention, when the speed of the zooming in or out is reduced, the speed at which the interocular distance is adjusted is reduced, and when the speed of the zooming in or out is increased, the speed at which the interocular distance is adjusted is increased.

In a preferred embodiment of this invention, when zooming in, the interocular distance is reduced, and when zooming out, the interocular distance is increased.

In order to accomplish the above object, the present invention provides an apparatus for capturing a stereographic image, comprising: a left-eye camera and a right-eye camera; a camera rig on which the left-eye camera and the right-eye camera are installed; and a camera rig control module configured to control movement of the camera rig and thus control the left-eye camera and the right-eye camera installed on the camera rig, wherein the camera rig control module comprises: an interocular-distance-DB storage unit creating and storing an interocular distance DB (database), the interocular distance DB including information both about an interocular distance between the left-eye camera and the right-eye camera at a reference distance, which is an initial image capturing distance between the camera rig and a target, and about an interocular distance to be changed when the image capturing distance is changed by zooming in or out from the reference distance; a changed-distance calculator using, when the left-eye camera and the right-eye camera are zoomed in or out at the reference distance, a change value of lens data changed by the zooming in or out and thus calculating an image capturing distance changed by zooming in or out on the target; and an interocular distance controller finding, from the interocular distance DB, a new interocular distance value corresponding to the image capturing distance changed by the zooming in or out, the interocular distance controller adjusting, using motors installed in the camera rig control module, the interocular distance between the cameras to the new interocular distance value found from the interocular distance DB.

In a preferred embodiment of this invention, the apparatus for capturing a stereographic image further comprises an interocular-distance-speed controller calculating a speed of the zooming in or out using a speed at which the lens data varies and controlling a speed at which the interocular distance is adjusted to correspond to the speed of the zooming in or out.

In a preferred embodiment of this invention, the apparatus for capturing a stereographic image further comprises a distance sensor measuring a distance between the camera rig and the target.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating the relationship between an interocular distance and an image-capturing distance of a camera rig;

FIGS. 2A and 2B are views showing an example of adjusting the interocular distance depending on the image-capturing distance when capturing an image in a zoomed-in state;

FIGS. 3A and 3B are views showing an example of adjusting the interocular distance depending on the image-capturing distance when capturing an image in a zoomed-out state; and

FIG. 4 is a table illustrating optimal interocular distances depending on image-capturing distances.

### DESCRIPTION OF THE PREFERRED EMBODIMENTS

Hereinafter, an exemplary embodiment of the present invention will be described in detail with reference to the attached drawings. However, the present invention is not limited to the exemplary embodiment. The same reference numerals are used throughout the different drawings to designate the same or similar components.

During a process of capturing stereographic images, cameras must frequently zoom in or out on a target to optimize the three-dimensional effect of the created stereographic image. When a camera module, which includes a left-eye camera and a right-eye camera, zooms in or out on the target, the distance, as is apparent on a screen, between the target and the camera module is varied.

Furthermore, the sense of depth of a stereographic image varies depending on the zoom-in or -out operation. The sense of depth is significantly influenced by the interocular distance (IOD) between the left-eye camera and the right-eye camera.

Binocular disparity and the vergence angle are representative stereognostic perception factors that are required in order to enable a person to perceive a stereographic image. The binocular disparity is a stereognostic perception factor, which occurs because the two eyes of a person are spaced apart from each other by about 64 mm. When the binocular disparity is comparatively large, persons feel that the distance to a target is short. When the binocular disparity is comparatively small, persons feel that the distance to a target is long. The vergence angle is a stereognostic perception factor, which occurs because the eyes of a person can rotate. The vergence angle refers to the angle between both eyes having a target as a vertex when the eyes are focused on the target. The vergence angle varies depending on the rotation of the eyes of the person toward the target. As the vergence angle increases (as the eyes rotate inward), the distance to the target as perceived by the viewer is reduced because the proportion of the area of a side surface of the target that can be seen by the person is increased. As the vergence angle is reduced, the perceived distance to the target is increased.

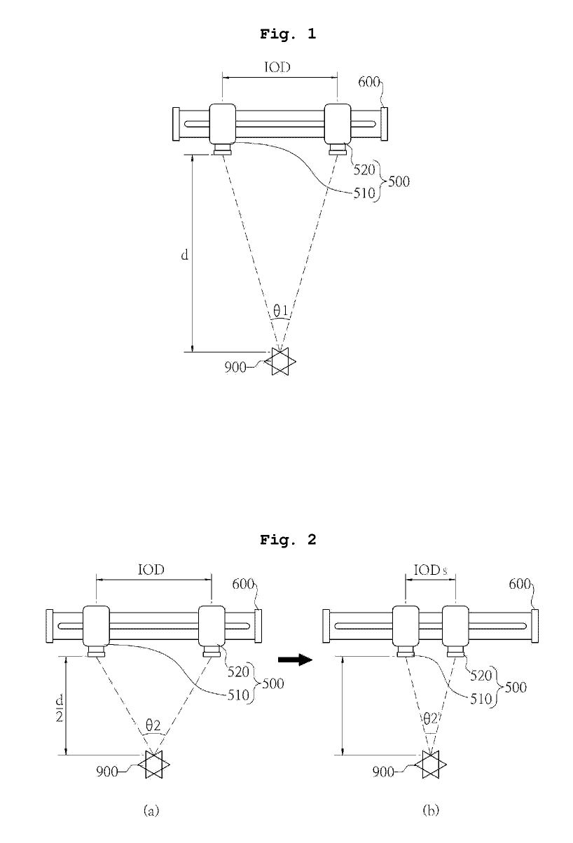

In an apparatus for capturing a stereognostic image, the binocular disparity and the vergence angle depend on each other. As shown in FIG. 1, as the interocular distance IOD corresponding to the binocular disparity increases, the vergence angle θ1 is also increased. As the interocular distance IOD corresponding to the binocular disparity is reduced, the vergence angle θ1 is also reduced.

While zooming in or out, an image capturing distance d between the camera module and the target is reduced or increased on the screen. When the image capturing distance d varies while the interocular distance IOD between the cameras is fixed, the vergence angle also varies depending on the image capturing distance d.

However, if the vergence angle rapidly varies because of rapid variation in the image capturing distance d during the zoom-in or -out operation, a viewer who watches stereognostic images may feel that an object in the images protrudes toward the user, or moves away therefrom, excessively rapidly. This excessively rapid variation in the vergence angle, that is, in depth perception, may cause eye strain of the viewer. Given this, there is the need for the depth perception to vary gradually.

For this, if interocular distances corresponding to image capturing distances are calculated in advance and stored in a table as a database DB, when capturing stereographic images, the interocular distance corresponding to a real image capturing distance can be easily determined from the table stored in the database. If the two cameras of the camera module can be controlled such that they have the determined interocular distance therebetween, the vergence angle can be prevented from rapidly varying because of rapid variation in the image capturing distance, whereby the vergence angle can smoothly vary so that the eye strain of the viewer can be minimized.

To achieve the above-mentioned purpose, the stereographic image capturing apparatus according to an exemplary embodiment of the present invention includes a camera module 500, a camera rig 600, and a camera rig control module (not shown). The camera module 500 includes a left-eye camera 510 and a right-eye camera 520.

The left-eye camera 510 and the right-eye camera 520 are installed on the camera rig 600. The camera rig control module controls the movement of the camera rig 600 so as to control the left-eye camera 510 and the right-eye camera 520, which are installed on the camera rig 600.

The camera rig control module includes an interocular-distance-DB storage unit, a changed-distance calculator, an interocular distance controller, and an interocular-distance-speed controller.

The interocular-distance-DB storage unit creates an interocular distance DB and stores it therein. The interocular distance DB includes information both about the interocular distance between the left-eye camera 510 and the right-eye camera 520 at a reference distance, which is the initial distance between the camera rig and the target, and about the interocular distance changed when the image capturing distance is changed by zooming in or out from the reference distance.

The changed-distance calculator uses, when the left-eye camera 510 and the right-eye camera 520 are zoomed in or out at the reference distance, a change value of lens data changed by zooming in or out, and thus calculates the image capturing distance, which has changed as a result of zooming in or out on the target.

The interocular distance controller finds, from the interocular distance DB, a new interocular distance value corresponding to the image capturing distance changed by zooming in or out, and adjusts, using motors installed in the camera rig control module, the interocular distance between the cameras to the new interocular distance value found from the interocular distance DB.

The interocular-distance-speed controller uses the speed of change in the lens data, calculates a zooming-in or -out speed, and then controls, corresponding to the zooming-in or -out speed, the speed at which to adjust the interocular distance.

The stereographic image capturing apparatus according to the embodiment of the present invention includes a distance sensor, which measures the distance between the camera rig and the target.

A method for adjusting the depth perception of a stereographic image using the stereographic image capturing apparatus having the above-mentioned configuration will be described.

The method includes: storing in advance information about interocular distances corresponding to a plurality of image capturing distances and arranging the information into an interocular distance DB; calculating, using lens data changed by zooming in or out the cameras, the changed image capturing distance; and finding from the interocular distance DB a new interocular distance corresponding to the calculated image capturing distance and adjusting the interocular distance of the cameras to the new interocular distance obtained from the interocular distance DB.

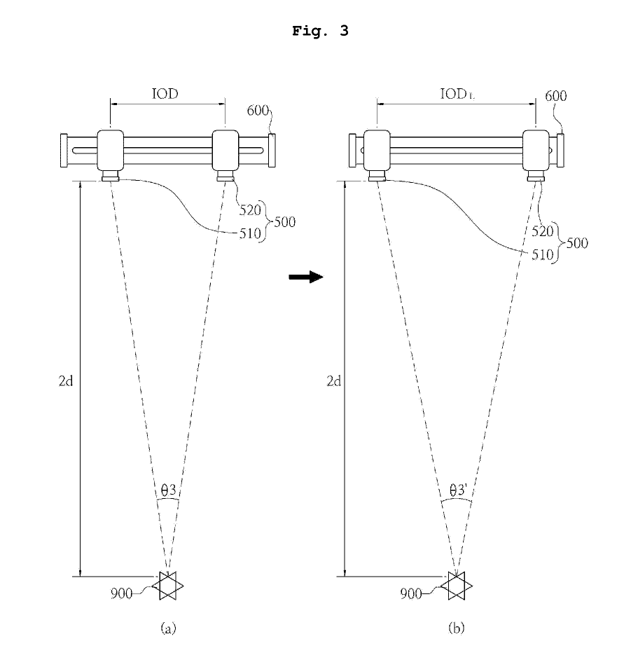

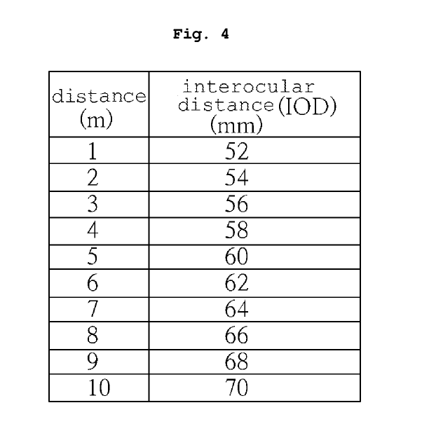

FIGS. 2A and 2B are views showing an example of adjusting the interocular distance depending on the image-capturing distance when capturing an image in a zoomed-in state. FIGS. 3A and 3B are views showing an example of adjusting the interocular distance depending on the image-capturing distance when capturing an image in a zoomed-out state. FIG. 4 is a table illustrating optimal interocular distances depending on image-capturing distances.

Referring to the drawings, the initial image capturing distance of the cameras is set to a reference distance. Information both about the interocular distance at the reference distance and about an interocular distance corresponding to an image capturing distance that is changed when the cameras are zoomed in or out at the reference distance is arranged into a table to form an interocular distance DB. The interocular distance DB is stored in the camera rig control module.

FIG. 4 illustrates an example of the interocular distance DB. When it is assumed that the image capturing distance of 10 m is the reference distance, the interocular distance is 70 mm at the reference distance. When the image capturing distance is reduced to 5 m by zooming in the cameras, the interocular distance becomes 60 mm.

Here, the reference distance is measured by the distance sensor.

During the actual stereographic image capturing process, when the image capturing distance, which was 10 m, is reduced to 5 m by zooming in on the target, the vergence angle is increased if the target is zoomed in on without varying the interocular distance. Referring to FIGS. 2A and 2B, when the image capturing distance of the cameras that have captured a stereographic image at the reference distance of 10 m is reduced from ‘d’ to ‘d/2’ by zooming in, the vergence angle is increased from θ1 to θ2. If the vergence angle is repeatedly and rapidly increased or reduced, the viewer who watches stereographic images suffers eye strain. There is the need to mitigate such eye strain.

For this, the interocular distance is adjusted according to the table of the interocular distance DB, whereby the eye strain of the viewer can be mitigated. Referring to the interocular distance DB of FIG. 4, when the image capturing distance is 5 m, the interocular distance is 60 mm. Furthermore, when the interocular distance is automatically adjusted to 60 mm by rotation of the motors installed in the camera rig control module, the vergence angle is changed to θ2′, which is less than θ2. Then, the viewer can be prevented from experiencing rapid variation in the vergence angle.

As shown in FIGS. 3A and 3B, if the interocular distance is increased in the above-mentioned manner when the image capturing distance is increased to 2d by the zooming-out operation, the vergence angle can smoothly vary from θ1 to θ3′ rather than rapidly varying from θ1 to θ3, thus mitigating eye strain of the viewer.

In this way, while zooming in, the interocular distance is reduced, and while zooming out, the interocular distance is increased. Thereby, eye strain of the viewer can be reduced.

Lens data is used to calculate the change in the image capturing distance when zooming in or out. Typically, a camera lens unit provides current lens data and enables the user to check lens data, which varies when zooming in or out. The lens data, which indicates variation in magnification of the lens, generally uses the rotation angle (or value) of the lens and indicates, by numerals, a value corresponding to the rotation angle.

Using such lens data makes it possible to calculate the changed value of the image capturing distance. In the present invention, the camera rig control module installed in the camera module calculates the change value and provides it.

When the interocular distance is adjusted, the speed at which the interocular distance varies is also controlled corresponding to the speed at which the interocular distance is adjusted. The speed at or degree to which the lens data varies can be used to calculate the speed of zooming in or out.

When the zooming-in or -out speed is comparatively low, the speed at which the interocular distance is adjusted is reduced. When the zooming-in or -out speed is comparatively high, the speed at which the interocular distance is adjusted is increased.

As described above, in the present invention, the interocular distance of a camera module can be appropriately controlled corresponding to variation in the image capturing distance depending on the zooming-in or -out operation of the camera module. Thereby, the eye strain of a viewer, who may suffer when watching stereographic images, can be minimized.

Although the exemplary embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method for controlling depth perception of a stereographic image using a stereographic image capturing apparatus including a camera module, a camera rig, and a camera rig control module, the camera module including a left-eye camera and a right-eye camera, the method comprising:
creating an interocular distance DB (database) including information both about an interocular distance determined at a reference distance and about an interocular distance to be changed when an image capturing distance is changed by zooming in or out at the reference distance, and storing the interocular distance DB in the camera rig control module;
using, in the camera rig control module, when the camera module including the left-eye camera and the right-eye camera is zoomed in or out at the reference distance, a change value of lens data changed by the zooming in or out and calculating an image capturing distance changed by zooming in or out on a target; and
finding, from the interocular distance DB, a new interocular distance value corresponding to the image capturing distance changed by zooming in or out, and adjusting, by means of rotating motors installed in the camera rig control module, the interocular distance of the camera module to the new interocular distance value found from the interocular distance DB.

2. The method as set forth in claim 1, wherein the adjusting the interocular distance of the camera module comprises:
using a speed at which the lens data varies and calculating a speed of the zooming in or out; and
controlling a speed at which the interocular distance is adjusted corresponding to the speed of the zooming in or out.

3. The method as set forth in claim 2, wherein when the speed of the zooming in or out is reduced, the speed at which the interocular distance is adjusted is reduced, and when the speed of the zooming in or out is increased, the speed at which the interocular distance is adjusted is increased.

4. The method as set forth in claim 1, wherein when zooming in, the interocular distance is reduced, and when zooming out, the interocular distance is increased.

5. An apparatus for capturing a stereographic image, comprising:
a left-eye camera and a right-eye camera;
a camera rig on which the left-eye camera and the right-eye camera are installed; and
a camera rig control module configured to control movement of the camera rig and thus control the left-eye camera and the right-eye camera installed on the camera rig,
wherein the camera rig control module comprises:
an interocular-distance-DB storage unit creating and storing an interocular distance DB (database), the interocular distance DB including information both about an interocular distance between the left-eye camera and the right-eye camera at a reference distance, which is an initial image capturing distance between the camera rig and a target, and about an interocular distance to be changed when the image capturing distance is changed by zooming in or out from the reference distance;
a changed-distance calculator using, when the left-eye camera and the right-eye camera are zoomed in or out at the reference distance, a change value of lens data changed by the zooming in or out and thus calculating an image capturing distance changed by zooming in or out on the target; and
an interocular distance controller finding, from the interocular distance DB, a new interocular distance value corresponding to the image capturing distance changed by the zooming in or out, the interocular distance controller adjusting, using motors installed in the camera rig control module, the interocular distance between the cameras to the new interocular distance value found from the interocular distance DB.

6. The apparatus as set forth in claim 5, further comprising:
an interocular-distance-speed controller calculating a speed of the zooming in or out using a speed at which the lens data varies and controlling a speed at which the interocular distance is adjusted to correspond to the speed of the zooming in or out.

7. The apparatus as set forth in claim 5, further comprising:
a distance sensor measuring a distance between the camera rig and the target.
